(19) United States
(12) Patent Application Publication
(10) Pub. No.: US 2013/0028675 A1
(43) Pub. Date: Jan. 31, 2013

(54) Tool Head and Method of Cutting Machining

(71) Applicants: Ulrich Vogler, Uhldingen-Muhlhofen (DE); Francois Brouet, Straubenhardt (DE); Thorsten Fausta, Marxzell (DE)

(72) Inventors: Ulrich Vogler, Uhldingen-Muhlhofen (DE); Francois Brouet, Straubenhardt (DE); Thorsten Fausta, Marxzell (DE)

(73) Assignee: Herrmann Ultraschalltechnik GmbH & Co. KG, Karlsbad (DE)

(21) Appl. No.: 13/558,637

(22) Filed: Jul. 26, 2012

(30) Foreign Application Priority Data
Jul. 28, 2011 (DE) 10 2011 052 252.2

(51) Int. Cl. B23B 37/00; B23B 31/00

(52) U.S. Cl. 408/1 R; 408/17

(57) ABSTRACT

The present invention concerns a tool head comprising a machine connection for connecting the tool head to a machine tool, and a tool 5 portion which either has at least one geometrically defined cutting edge or has a receiving means for a tool insert having a geometrically defined cutting edge. To provide a tool head, like a drilling head, and a method with which highly precise machining is possible with very high feed speeds and good surface quality without the cutting edge being exposed to 10 a high rate of wear, it is proposed that there is a converter for converting electrical AC voltage into a mechanical vibration, wherein the converter is arranged, designed and connected to the tool portion so that the unit comprising the converter and the tool portion and possibly a tool insert 15 received in the receiving means can be excited to perform an ultrasonic vibration.

The present invention concerns a tool head and a method of cutting machining of a workpiece.

Usually a tool head has a machine connection for connecting the tool head to a machine tool as well as a tool portion. The tool portion either has at least one geometrically defined cutting edge provided for coming into engagement with and machining a workpiece, or it has a receiving means for a tool insert which then has the geometrically defined cutting edge.

Such tool heads are used for example in drilling, milling or turning or other cutting methods with a geometrically defined cutting edge.

The invention is described hereinafter with reference to a drilling head as it is here that the action according to the invention is at its most pronounced. In principle the tool head however can for example also be in the form of a milling head or a turning head.

Usually a drilling head has a spindle connection for connecting the drilling head to a rotatable spindle, and a tool portion. The tool portion can either itself be in the form or a drill or borer or can have a receiving means for same. In both cases it is possible for the cutting edges of the drill or borer to be formed by interchangeable cutting inserts. The borer can be for example in the form of a twist drill.

Such a drill generally has a shank portion intended to be received in a corresponding chuck, for example in the stated drill head, and a cutting portion which is intended to come into engagement with the workpiece to be machined. If the borer is in the form of a twist drill, the cutting portion has at least one and frequently two flutes extending in a spiral shape around the cutting portion. Provided at the end face of the cutting portion is at least one but preferably two main cutting edges for the cutting machining operation. The flutes are delimited at the peripheral side by secondary cutting edges which however generally do not come into engagement with the workpiece.

Round bores can be produced in a workpiece with such drilling heads. It will be appreciated however that the feed speed is limited by the material to be machined, the load-bearing capability of the cutting edges and the desired surface quality of the drilling operation.

It is already known, in the case of particularly hard materials, to apply blows to the twist drill in the axial direction towards the workpiece. By means of that so-called hammer drilling it is possible to form corresponding holes in concrete or other hard materials. Hammer drilling however is less suitable for producing high-precision bores, that is to say holes of a highly precise inside diameter.

Without the hammering effect used in hammer drilling conventional drilling heads however, particularly when dealing with hard materials, require a relatively long time to drill a hole of high accuracy. Admittedly it is in principle possible to increase the feed speed of the drill even without the hammer function, but that results in markedly increased wear of the cutting edges and a reduced surface quality.

Based on the described state of the art therefore the object of the present invention is to provide a tool head, in particular a drilling head, and a method, with which highly precise cutting machining is possible with very high feed speeds and good surface quality without the cutting edge being exposed to a high rate of wear.

In regard to the tool head that object is attained in that there is provided a converter for converting electrical AC voltage into a mechanical vibration, wherein the converter is arranged, designed and connected to the tool portion in such a way that by means of the converter the unit comprising the converter and the tool portion and possibly a tool insert received in the receiving means can be excited to perform an ultrasonic vibration.

Ultrasound is a mechanical vibration above the audible limit. The frequency range begins at about 20 KHz and extends up to frequencies of 1 GHz. Such ultrasonic frequencies are frequently produced by means of piezoelectric sound transducers from electrical energy. In that respect the piezoelectric sound transducers are matched to the geometry of the converter in such a way that the converter can be excited to an inherent vibration by the piezoelectric sound transducers. In other words the converter is of a length corresponding to a multiple of half the wavelength (n· λ/2 with n=1, 2, 3, 4, . . . ) of the ultrasonic vibration generated by the piezoelectric sound transducers. Then, in the excited condition, a vibration maximum is formed at the end faces of the converter so that this entails good transmission of the ultrasonic vibration to the tool portion mounted to the end face.

The tool portion optionally together with the received tool insert is in turn of a geometry which ensures that the tool portion has an inherent vibration at the same frequency. Therefore the tool portion is also of a length (in the direction of the drilling axis) corresponding to a multiple of half the wavelength (n· λ/2 with n=1, 2, 3, 4, . . . ) of the ultrasonic vibration generated by the piezoelectric sound transducers.

In principle it is not necessary for the converter to be connected directly to the tool portion. For example it is also possible for an amplitude transformer to be interposed. The tool portion, possibly together with the tool insert received in the receiving means, serves as a sonotrode. The converter thus excites the ultrasonic vibrating unit consisting of converter, tool portion and possibly a tool insert received in the receiving means, with an inherent vibration so that a standing wave is produced in the ultrasonic vibrating unit, in which case an ultrasonic vibration maximum is produced in the region of the cutting edges of the tool insert.

In a preferred embodiment the tool head is a boring or drilling head so that the machine connection is in the form of a spindle connection and the tool portion either itself serves as the borer or drill or has a receiving means for same. A twist drill is best used.

By virtue of the geometry of the twist drill a longitudinal ultrasonic vibration additionally leads to a torsional movement of the twist drill in the region of the helical flutes.

In other words, in the case of conventional drills, an ultrasonic vibration is impressed on the tool portion, in particular the twist drill, and that leads to more effective cutting removal without the high level of accuracy being impaired.

In a further preferred embodiment a generator generating an electrical AC voltage is connected to the converter, wherein the AC voltage generated by the generator is of a frequency which substantially corresponds to an inherent frequency of the unit consisting of converter and tool portion and possibly a tool insert received in the receiving means. In that respect it will be appreciated that the frequency generated by the generator does not have to exactly coincide with the inherent frequency of the ultrasonic vibrating unit as slight deviations between the excitation frequency and the inherent frequency nonetheless lead to a useable ultrasonic vibration in the system. In addition the inherent frequency of the ultrasonic vibrating unit changes somewhat at the moment at which the cutting edge of the twist drill comes into contact with the workpiece to be machined so that in any case in operation there are minor mismatchings of the excitation frequency to the inherent frequency.

It is possible in principle for the tool portion itself to have a portion in the form of a borer or drill. As however the tool portion must be relatively laboriously produced in order to ensure that the ultrasonic vibration generated by the converter actually reaches the tip of the drill in as concentrated a form as possible and in addition the drill, by virtue of its engagement with the workpiece to be machined, is subjected to not inconsiderable wear, it is instead advantageous if the tool portion has a receiving means for a drill so that, in the event of wear of the drill, only the drill can be removed from the receiving means and replaced by another drill. The tool portion can thus continue to be used.

To achieve transmission of the ultrasonic vibration to the twist drill, that is as good as possible, it has been found that it is best for the twist drill to be arranged in the receiving means of the tool portion by means of a shrink fit. In other words the twist drill is of an outside diameter somewhat larger than the inside diameter of the receiving means of the tool portion.

To receive the twist drill in the receiving means of the tool portion therefore the tool portion is heated and/or the twist drill is cooled so that the shank of the twist drill can be introduced into the receiving means of the tool portion by virtue of the thermal expansion. As soon as the twist drill and the tool portion have reached substantially the same temperature again the twist drill is held fixedly in the receiving means. That kind of fixing also has the advantage that the twist drill can be easily positioned reproducibly highly accurately in the radial direction so as to ensure that the axis of the drill coincides with the axis of the tool portion and a high degree of rotational truth and accuracy is achieved.

In a preferred embodiment the receiving means of the tool portion provides an abutment for the twist drill, which limits the position of the twist drill in the axial direction. That abutment ensures that the twist drill is held at exactly the desired position upon insertion into the receiving means. Upon matching of the tool portion to the twist drill, it is possible to ensure, as already stated in the opening part of this specification, that the end of the twist drill, that is to say the part of the twist drill that first comes into contact with the workpiece is arranged in the region of a vibration maximum of the ultrasonic vibration. That presupposes that the tip and thus the main cutting edges of the twist drill are at an exactly predetermined axial position. If the twist drill is pushed too far into the receiving means or is not pushed completely into the receiving means to the desired position, that results in a change in the inherent frequency of the vibrating system so that the converter is no longer optimally matched to the frequency and that can involve energy losses that cannot be disregarded. The combination of tool portion and drill should always be an λ/2 oscillating system or a multiple thereof with respect to the working frequency of the converter.

In principle the drilling head according to the invention can be used with commercially usual twist drills. Generally however they are of differing lengths. In a further preferred embodiment therefore it is provided that the abutment is moveable and can be fixed to the tool portion in at least two positions spaced axially from each other. Then, depending on the respective twist drill used, the abutment can be suitably adjusted so as to ensure that the tip of the twist drill comes to lie at the desired position. That measure provides therefore that the same tool portion can be used for a multiplicity of twist drills of differing lengths. It will be noted however that it is only possible to compensate for twist drill length differences which are no greater than the spacing between the two positions in which the abutment can be fixed to the tool portion. As soon as the drill is fixed relative to the tool portion, for example by means of the above-mentioned shrink fit, the abutment can be removed from the tool portion.

If twist drills with even greater drill length differences are to be used the tool portion cannot be used in all cases. In a preferred embodiment it is therefore provided that the tool portion is removable from the converter or the amplitude transformer fixed to the converter.

It is further advantageous if there are at least two tool portions which can be selectively connected to the converter or the amplitude transformer, wherein the two tool portions are of a differing length in the axial direction. In other words each tool portion is designed for other twist drill lengths and/or twist drill diameters so that, depending on the respective twist drill to be used, the corresponding tool portion is used, which in turn can provide for limited adjustability of an abutment which is preferably included. It is advantageous if a set comprising a drilling head and at least one but preferably a plurality of tool portions which differ from each other is available to the user. The user can then use virtually any desired available drill with the drilling head. It is only necessary to select the correct tool portion and fix it to the converter or the amplitude transformer.

In that respect in a further preferred embodiment it is provided that the converter and the tool portion are fixed to each other in such a way that one of the elements has a recess into which the other element engages, thereby providing for radial positioning of the two parts relative to each other and thus a high level of rotational accuracy. For example an element can have a projection with a portion of a conical configuration, which engages into the correspondingly shaped recess in the other element.

In a further preferred embodiment the tool portion has a through bore which extends in the axial direction and which at its one end has a portion with a female thread for fixing the tool portion to the converter or an element fixed to the converter and the other end represents the receiving means for a tool insert. Such an embodiment is simple to manufacture. Moreover, for the situation where the twist drill has internally extending coolant and/or lubricant passages, coolant and/or lubricant can be fed by way of that through bore.

Likewise it would be possible for the tool portion to be fixed to the converter by means of a shrink fit. In the heating operation however it is then necessary to ensure that the piezoelectric elements are not overheated and as a result depolarized.

In regard to the method of the above-outlined object is attained by a method of cutting machining of a workpiece in which a tool with a geometrically defined cutting edge is brought into engagement with the workpiece to be machined and the tool and the workpiece are moved relative to each other, wherein the tool is caused to perform an ultrasonic vibration during the machining operation. In principle the method is not limited to the use of borers or drills. It would also be conceivable to use the machining method for milling or turning. It is only essential that the tool and in particular the cutting edge that comes into contact with the workpiece to be machined is caused to perform an ultrasonic vibration during the machining operation.

If the tool head is operated at high rotary speeds, for example 20,000 rpm, it is advantageous in terms of rotational truth and accuracy and the stress loading on the components if the drilling head is previously balanced. That can be effected for example on balancing apparatuses suitable for that purpose.

Further advantages, features and possible uses will be apparent from a description hereinafter of a preferred embodiment and the associated drawings in which:

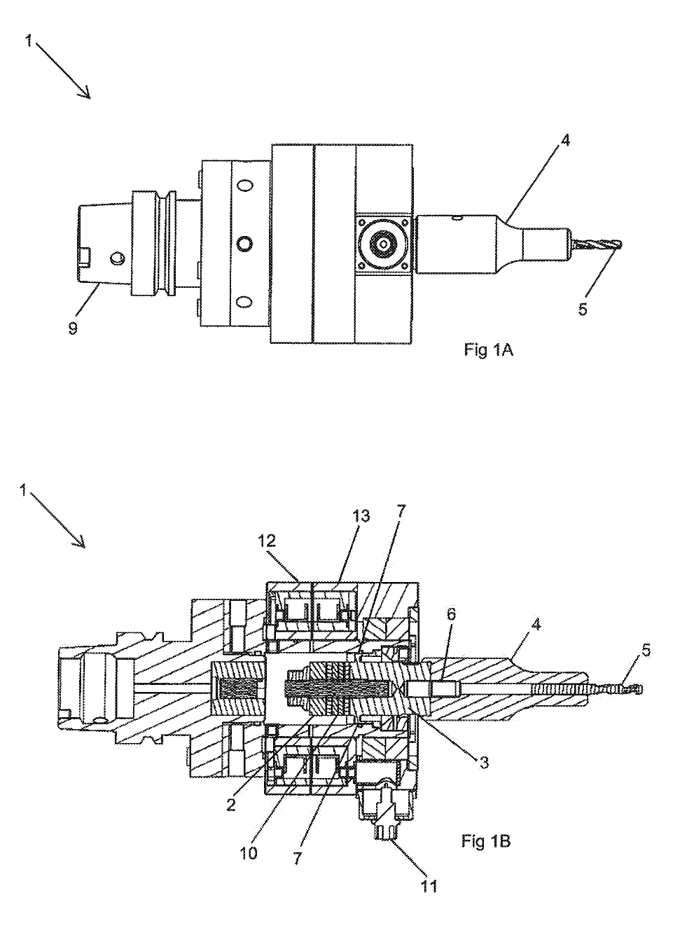

FIGS. 1A and 1B show an embodiment of a drilling head according to the invention,

FIGS. 2A and 2B show views of the tool portion shown in FIGS. 1A and 1B,

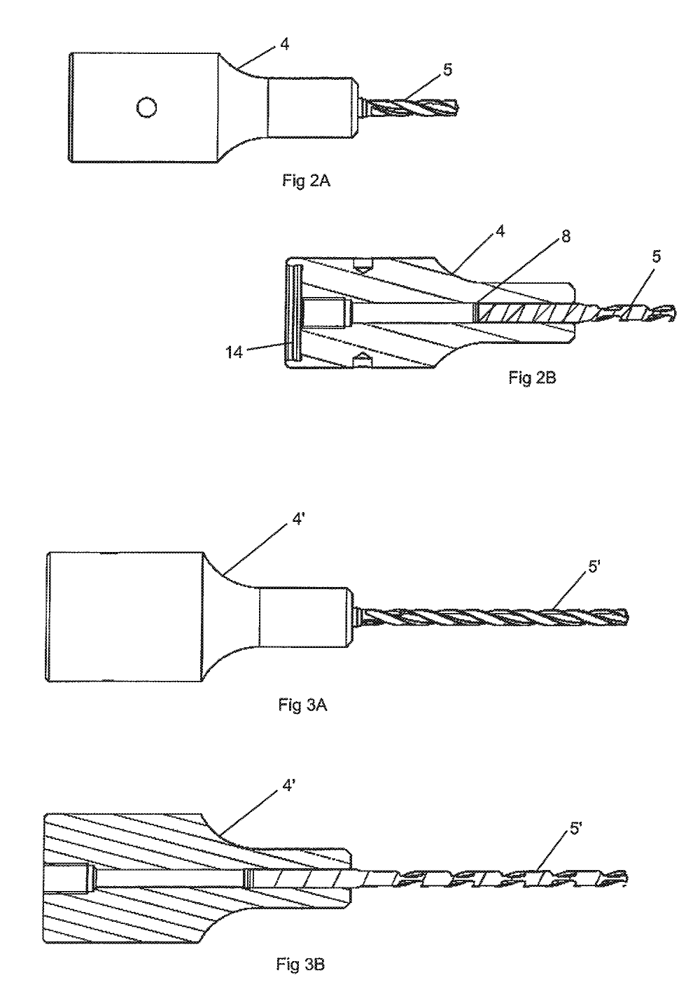

FIGS. 3A and 3B show an alternative embodiment of the tool portion, and

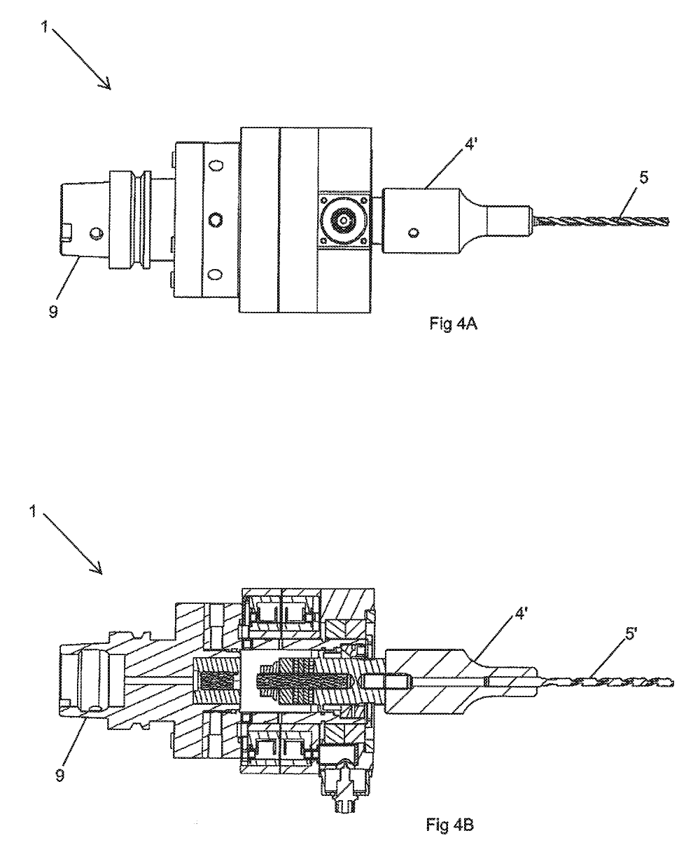

FIGS. 4A and 4B show the drilling head according to the invention with the tool portion of FIGS. 3A and 3B.

FIGS. 1A and 1B show a preferred embodiment of the drilling head 1 according to the invention. FIG. 1A shows a side view while FIG. 1B shows a sectional view. At its one end the drilling head has a spindle connection 9 with which the drilling head can be connected to a rotatable spindle. The spindle connection 9 is here in the form of an HSK connection but in principle it can be of any desired form as long as connection to a rotatable spindle is possible.

The drilling head 1 has a converter for converting electrical AC voltage into a mechanical ultrasonic vibration. The converter here comprises inter alia the steel disk 2, the piezoelectric disks 10 and the lower converter portion 3. The steel disk 2 and the piezoelectric disks 10 are fixed to the lower converter portion 3 by means of a screw and a nut.

The tool portion 4 can have a through bore in which a twist drill 5 can be received.

At the side of the through bore, remote from the twist drill 5, the through bore can have a female thread, by means of which the drill portion 4 can be fixed by means of a setscrew to the amplitude transformer 3. The oscillating system comprising the converter, the tool portion 4 and the twist drill 5 can be caused to perform an ultrasonic vibration by the converter 2.

To minimize the transmission of the ultrasonic vibration to the drilling head that ultrasonic vibrating unit is fixed to the drilling head by means of the holder 7. The holder 7 can engage at a point on the ultrasonic vibrating unit in which the longitudinal ultrasonic vibration has a vibration minimum.

By virtue of a particular geometrical configuration of the holding arrangement the thickness vibration, that is to say the transverse vibration, of the vibrating system, which does not have a minimum at that location, can be absorbed without it being transmitted to the housing of the drilling head.

The geometrical configuration of the holder 7 must also take account of the fact that forces occurring can be transmitted by the drill (axial and torsional).

Likewise centrifugal forces which occur at high rotary speeds can be absorbed.

Therefore “soft” mounting configurations such as for example 0-rings are not to be meaningfully used at that location.

Basically the tool portion 4 and the twist drill 5 together form a sonotrode. The individual components of the ultrasonic vibrating unit are so matched to each other that, with correct positioning of the twist drill 5 within the receiving means of the tool portion 4, a maximum in respect of the longitudinal ultrasonic vibration occurs at the tip of the twist drill and a vibration minimum occurs in the region of the holder 7.

The necessary energy supply is effected by way of the connection 11. Provided for transmitting the energy to the rotating converter is a rotary coupler 12,13 comprising a stationary portion 13 and a rotating portion 12.

FIGS. 2A and 2B once again show the tool portion 4 on an enlarged scale. It will be seen that in the region of its through bore the tool portion 4 can have an abutment 8 which establishes the axial position of the twist drill 5 in the receiving means of the tool portion 4. The tool portion 4 can be matched to the twist drill 5 so that a vibration maximum of the longitudinal ultrasonic vibration is formed at the tip of the twist drill 5.

In principle it is possible to use commercially available twist drills. If a longer twist drill is used then that twist drill, if the tool portion 4 in FIGS. 2A and 2B is to be used, must be pushed further into the receiving means insofar as the abutment 8 allows that. That however is only possible for twist drills which do not differ excessively in their length. If instead a twist drill is to be used, which is of a markedly different length, it is necessary to separate the tool portion 4 from the drilling head 1 and replace it by another tool portion.

A further tool portion is shown in FIGS. 3A and 3B, illustrating a plan view and a sectional view. The tool portion 4′ illustrated here is of a greater extent in the axial direction so that it is possible to receive the twist drill 5′ which is longer in comparison with that shown in FIGS. 2A and 2B. The tool portion 4′ shown in FIGS. 3A and 3B can be connected to the drilling head shown in FIG. 1. That situation is shown in FIGS. 4A and 4B.

At its side towards to the converter the tool portion shown in FIGS. 2A and 2B has a recess 14, the inside contour of which is matched to the outside contour of the lower converter portion 3. That ensures that the tool portion is always exactly positioned in the radial direction and very good rotational truth accuracy is achieved. In principle however it would also be possible here to have a shrink fit connection or a conical connection.

High-precision boring holes can therefore be produced at a high feed speed by the drilling head according to the invention with commercially usual twist drills and commercially usual drilling machines.

### LIST OF REFERENCES

1 Drilling head
2 Disk
3 Lower converter portion
4, 4′ Tool portion
5, 5′ Twist drill
6 Threaded bore
7 Holder
8 Abutment
9 Spindle connection
10 Piezoelectric disks
11 Connection
12,13 Rotary coupler
14 Recess

1. A tool head comprising a machine connection for connecting the tool head to a machine tool, and a tool portion which either has at least one geometrically defined cutting edge or has a receiving means for a tool insert having a geometrically defined cutting edge, characterised in that that there is provided a converter for converting electrical AC voltage into a mechanical vibration, wherein the converter is arranged, designed and connected to the tool portion in such a way that by means of the converter the unit comprising the converter and the tool portion and possibly a tool insert received in the receiving means can be excited to perform an ultrasonic vibration of a wavelength λ.

2. A tool head as set forth in claim 1 characterised in that the tool head is in the form of a drilling head, the machine connection is a spindle connection for connecting the drilling head to a spindle driven by a machine tool, and the tool portion is either in the form of a drill or has a receiving means for a drill.

3. A tool head as set forth in claim 1 characterised in that a generator generating an electrical AC voltage is connected to the converter and the AC voltage generated by the generator is of a frequency which substantially corresponds to an inherent frequency of the unit consisting of converter and tool portion and possibly a tool insert received in the receiving means.

4. A tool head as set forth in one of claims 1 through 3 characterised in that the tool portion has a receiving means for a tool and a tool is arranged in the receiving means by means of a shrink fit, wherein preferably the tool is a drill.

5. A tool head as set forth in one of claims 1 through 3 characterised in that the tool portion has a receiving means for a tool and the receiving means provides an abutment for the tool, which limits the position of the tool in a direction, wherein preferably the abutment is movable and can be fixed to the tool portion in at least two positions which are spaced from each other.

6. A tool head as set forth in claim 5 characterised in that the abutment is provided by an element which is removable from the tool portion.

7. A tool head as set forth in one of claims 1 through 3 characterised in that the tool portion is removable from the tool and there are at least two tool portions which can be selectively connected to the tool head, wherein the two tool portions are of a differing size.

8. A tool head as set forth in claim 7 characterised in that either the tool portion has a recess which is so adapted that the converter or a pin fixed to the converter can be received in the recess, or the converter has a recess which is so adapted that the tool or a pin fixed to the tool portion can be received in the recess.

9. A tool head as set forth in claim 7 characterised in that the tool portion has a through bore which at its one end has a portion with a female thread for fixing the tool portion to the converter or an element fixed to the converter and the other end represents the receiving means for a tool insert.

10. A tool head as set forth in one of claims 1 through 3 characterised in that the tool portion optionally together with a tool insert received in the receiving means is of a length corresponding to a multiple of half the wavelength (n· λ/2 with n=1, 2, 3, 4, . . . ) of the ultrasonic vibration.

11. A tool head as set forth in one of claims 1 through 3 characterised in that the converter is of a length corresponding to a multiple of half the wavelength (n· λ/2 with n=1, 2, 3, 4, . . . ) of the ultrasonic vibration.

12. A method of cutting machining of a workpiece in which a tool with a geometrically defined cutting edge is brought into engagement with the workpiece to be machined and the tool and the workpiece are moved relative to each other, characterised in that the tool is caused to perform an ultrasonic vibration during the machining operation.

13. A method as set forth in claim 12 characterised in that a drill and preferably a twist drill is used as the tool.

14. A method as set forth in claim 12 or claim 13 characterised in that a tool head as set forth in one of claims 1 through 11 is used.
